(19) United States
(12) Patent Application Publication
(10) Pub. No.: US 2018/0223899 A1
(43) Pub. Date: Aug. 9, 2018

(54) ANGULAR CONTACT BALL BEARING, AND BALL SCREW DEVICE USING SAME

(71) Applicant: NTN CORPORATION, Osaka (JP)

(72) Inventor: Hiroki TANIMURA, Kuwana (JP)

(73) Assignee: NTN CORPORATION, Osaka (JP)

(21) Appl. No.: 15/941,897

(22) Filed: Mar. 30, 2018

Related U.S. Application Data
(63) Continuation of application No. PCT/JP2016/079464, filed on Oct. 4, 2016.

(30) Foreign Application Priority Data
Oct. 5, 2015 (JP) 2015-197525
Sep. 28, 2016 (JP) 2016-189478

(51) Int. Cl. F16C 19/16; F16C 33/38

(52) U.S. Cl. CPC F16C 19/163; F16C 33/3887

(57) ABSTRACT

Provided is an angular contact ball bearing that can have a load capacity increased by increasing the diameter of each ball and that is suitably used mainly to bear a thrust load. In the angular contact ball bearing, a plurality of balls are rollably interposed between an inner ring raceway groove formed on an outer peripheral surface of an inner ring and an outer ring raceway groove formed on an inner peripheral surface of an outer ring. The plurality of balls are retained by a plurality of separator retainers that are interposed between the adjacent balls and that are spaced apart from each other. A contact angle θ of each ball is within a range of 45° to 65°.

### CROSS REFERENCE TO THE RELATED APPLICATION

This application is a continuation application, under 35 U.S.C. § 111(a), of international application No. PCT/JP2016/079464, filed Oct. 4, 2016, which claims priority to Japanese patent application No. 2015-197525, filed Oct. 5, 2015, and Japanese patent application No. 2016-189478, filed Sep. 28, 2016, the disclosure of which are incorporated by reference in their entirety into this application.

### BACKGROUND OF THE INVENTION

### Field of the Invention

The present invention relates to an angular contact ball bearing used to support a ball screw of an injection molding machine, or the like, and a ball screw device using the angular contact ball bearing.

### Description of Related Art

An injection molding machine is provided with a feed mechanism that causes a resin material extrusion screw to advance/retract, or a feed mechanism that clamps a mold. These feed mechanisms have been recently electrified instead of a conventional hydraulic type. In an electric feed mechanism, a rotary motor and a ball screw are used.

The ball screw has a function to move two objects relative to each other and position the objects, and a function to convert rotational force to linear motion force. The ball screw used in the above injection molding machine is exclusively required to have the latter function. A bearing that supports such a ball screw used mainly to apply linear motion force receives a large thrust load, and thus, generally, a roller bearing is often used as the bearing. However, the roller bearing has great torque loss, and thus, in order to improve the efficiency of conversion of rotational force to linear motion force, the ball screw may be supported by an angular contact ball bearing which has less torque loss (for example, Patent Document 1).

### RELATED DOCUMENT

### Patent Document

[Patent Document 1] JP Laid-open Patent Publication No. 2009-236314

### SUMMARY OF THE INVENTION

When an angular contact ball bearing shown in FIG. 16 is used to support a ball screw used mainly to apply linear motion force, it is necessary to increase the diameter Da of each ball 3 to increase the load capacity of the angular contact ball bearing, in order to prolong the life of the angular contact ball bearing. In addition, in order to bear a large thrust load, it is necessary to make raceway grooves 1a and 2a of an inner ring 1 and an outer ring 2 deeper, or, in other words, make the heights of shoulder portions 1b and 2b of the inner ring 1 and the outer ring 2 larger such that the balls 3 are prevented from moving onto the shoulder portions 1b and 2b.

When the diameter Da of each ball 3 is increased and the heights of the shoulder portions 1b and 2b are made larger as described above with an inner diameter dimension d1, an outer diameter dimension D1, and a width dimension B that conform to the ISO standard (JIS B 1522), a space portion, between the inner ring 1 and the outer ring 2, in which no balls 3 are present becomes narrow, and no space for fitting a retainer 5 for retaining the balls 3 is left. Specifically, in the case of a ladder type or a comb type retainer 5, no space for disposing an annular portion 5a is left. Even if the annular portion 5a can be disposed, pillar portions 5b have to be thinned. During rapid acceleration/deceleration rotation, great force acts on the pillar portions 5b due to delay or advance of the balls, and thus the pillar portions 5b may be damaged if the pillar portions 5b are thin. That is, from the viewpoint of arrangement space and strength of the pillar portions 5b, it is difficult to use the ladder type or comb type retainer 5, which is generally used at present.

When the inner diameter dimension d1, the outer diameter dimension D1, and the width dimension B are set to dimensions that do not comply to the ISO standard, it is possible to set the diameter Da of each ball 3 and the depths of the raceway grooves 1a and 2a to appropriate values. However, in this case, the necessity to reconsider the structure around the ball screw arises, and the versatility is eliminated.

Under the above circumstances, a problem is to, in an angular contact ball bearing that bears a large thrust load, allow balls to be assuredly retained and increase the diameter of each ball in conformity to the ISO standard. In addition, another problem is to effectively apply an angular contact ball bearing to a ball screw device used mainly to apply linear motion force such as a feed mechanism for an extrusion screw of an injection molding machine.

An object of the present invention is to provide an angular contact ball bearing that can have a load capacity increased by increasing the diameter of each ball and that is suitably used mainly to bear a thrust load. Another object of the present invention is to provide a ball screw device that is suitably used mainly to apply linear motion force.

An angular contact ball bearing of the present invention includes: an inner ring having an outer peripheral surface formed with an inner ring raceway groove; an outer ring having an inner peripheral surface formed with an outer ring raceway groove; a plurality of balls rollably interposed between the inner ring raceway groove and the outer ring raceway groove; and a plurality of separator retainers configured to retain the plurality of balls, the separator retainers being interposed between the adjacent balls and that are spaced apart from each other, in which a contact angle of each ball is within a range of 45° to 65°.

According to this configuration, since the respective balls are retained by the plurality of separator retainers spaced apart from each other and not by a retainer of a ladder type, a comb type, or the like having pillar portions, damage of pillar portions due to delay or advance of the balls during rapid acceleration/deceleration rotation does not occur. In addition, since no pillar portions are included, the space between the inner ring and the outer ring is widened accordingly, and thus much grease can be put into the bearing, resulting in improved lubrication. When the separator retainers are formed from a resin, the grease holding ability is enhanced, resulting in further improved lubrication.

Since the contact angle of each ball is not less than 45°, a larger thrust load can be borne as compared to a radial load. In addition, since the contact angle of each ball is not greater than 65°, the balls can be prevented from moving onto a portion of the inner ring at a back side with respect to the inner ring raceway groove and a portion of the outer ring at the back side with respect to the outer ring raceway groove. As described above, the bearing can be used in an application in which a thrust load acts, and the load capacity thereof can be increased without an increase in the dimension of the entire bearing.

In the present invention, the balls may each have a diameter that is not less than 68% of ½ of a difference between an outer diameter dimension of the outer ring and an inner diameter dimension of the inner ring. Generally, when the diameter of each ball is not less than 68% of ½ of the difference, the proportion of the balls in the space between the inner ring and the outer ring is excessively high. Thus, in the case of a retainer having pillar portions, no space for disposing the pillar portions is left, and fitting of the retainer is difficult. In the case of the separator retainers, the separator retainers do not have any pillar portions, and thus can be used even when the diameter of each ball is not less than 68% of ½ of the difference.

In the present invention, a groove depth of a deepest portion of the inner ring raceway groove with respect to the portion of the inner ring at the back side with respect to the inner ring raceway groove and a groove depth of a deepest portion of the outer ring raceway groove with respect to the portion of the outer ring at the back side with respect to the outer ring raceway groove may be not less than 47% of the diameter of each ball. Chamfers are provided at the boundary between the inner ring raceway groove and the outer peripheral surface of the portion of the inner ring at the back side with respect to the inner ring raceway groove and the boundary between the outer ring raceway groove and the inner peripheral surface of the portion of the outer ring at the back side with respect to the outer ring raceway groove. In view of the chamfers, in the above configuration, the outer diameter dimension of the portion of the inner ring at the back side with respect to the inner ring raceway groove and the inner diameter dimension of the portion of the outer ring at the back side with respect to the outer ring raceway groove are considered to be substantially equal to the pitch circle diameter of the balls. For processing reasons, the outer diameter dimension of the portion of the inner ring at the back side with respect to the inner ring raceway groove cannot be made larger than the pitch circle diameter of the balls, and the inner diameter dimension of the portion of the outer ring at the back side with respect to the outer ring raceway groove cannot be made smaller than the pitch circle diameter of the balls. Therefore, the above configuration is considered as a mode in which it is possible to bear the substantially largest thrust load.

In the present invention, the outer diameter dimension of the portion of the inner ring at the back side with respect to the inner ring raceway groove and the inner diameter dimension of the portion of the outer ring at the back side with respect to the outer ring raceway groove may be equal to the pitch circle diameter of the balls. As described above, since the outer diameter dimension of the portion of the inner ring at the back side with respect to the inner ring raceway groove cannot be made larger than the pitch circle diameter of the balls, and the inner diameter dimension of the portion of the outer ring at the back side with respect to the outer ring raceway groove cannot be made smaller than the pitch circle diameter of the balls, this configuration is a mode in which it is possible to bear the substantially largest thrust load.

As will be described later with reference to FIG. 7 to FIG. 9, during rotation of the angular contact ball bearing, each separator retainer revolves while being brought into contact with and guided by the balls and raceway surfaces. At this time, if the dimension of each separator retainer is inappropriate, the posture of the separator retainer may become unstable, and the bearing may be locked. In addition, if the outer diameter dimension and the width dimension (the dimension in the circumferential direction) of each separator retainer are small, the separator retainer may fall off through the gap between the bearing rings.

Therefore, in the present invention, the separator retainers may each have an outer diameter and a width that are set to magnitudes such that, when the separator retainer is tilted between the adjacent two balls at a maximum angle in a circumferential direction of the bearing from a radial direction of the bearing, an radially outer end portion of the separator retainer comes into contact with one of the balls and an inner surface of the outer ring and an radially inner end portion of the separator retainer comes into contact with a portion of the other ball at an inner diameter side with respect to a pitch circle. When the outer diameter dimension and the width dimension of each separator retainer are set larger with respect to the diameter of each ball as described above, tilt of the separator retainer during revolution can be inhibited, the separator retainer can be prevented from being brought into a locked state where the separator retainer becomes stuck between the balls to inhibit rotation of the bearing, and at the same time, the separator retainer can be prevented from falling off through the gap between the bearing rings.

Preferably, the separator retainers used in the angular contact ball bearing may each have an outer diameter dimension that is 75 to 85% of the diameter of each ball, and may each have a width dimension that is 20 to 50% of the diameter of each ball. When the outer diameter dimension and the width dimension of each separator retainer are set within the predetermined ranges, the locked state and the falling-off state can be further assuredly avoided.

As will be described later with reference to FIG. 11, during rotation of the bearing, the separator retainers revolve while being brought into contact with and guided by the balls and the raceway surfaces. The gaps between the separator retainers and the balls are important for inhibiting sound of collision between the separator retainers and the balls for smooth rotation. When the gaps between the separator retainers and the balls are large, the separator retainers move outward in the radial direction due to centrifugal force to come into contact with the raceway surface of the outer ring. Accordingly, rotational torque increases, and problems such as heat generation arise. In addition, sound of collision between the separator retainers and the balls becomes loud, which causes noise. When the gaps between the separator retainers and the balls are small, the separator retainers and the balls thermally expand due to a temperature rise associated with rotation of the bearing, and the gaps between the separator retainer and the balls are reduced or eliminated. Thus, friction and heat are generated between the separator retainer and the balls, so that the life of the bearing is shortened.

Therefore, in the angular contact ball bearing, when all the balls and the separator retainers are gathered in a circumferential direction of the bearing to form an assembly, a gap between both ends of the assembly may be 15 to 25% of the diameter of each ball. Accordingly, an appropriate gap is maintained between the separator retainer and the ball during rotation of the bearing even in consideration of thermal expansion of the balls and the separator retainers, whereby the bearing can be smoothly rotated. Specifically, an increase in rotational torque and heat generation that occur due to contact of the separator retainers with the raceway surface, and noise that occurs due to the sound of collision between the balls and the separator retainers becoming loud, when the gap between the separator retainer and the ball is larger than 25% of the ball diameter, can be avoided. In addition, friction and heat generation that occur due to the gap between the separator retainer and the ball being eliminated due to thermal expansion of the balls and the separator retainers by a temperature rise during rotation of the bearing, when the gap between the separator retainer and the ball is smaller than 15% of the ball diameter, can be avoided.

Since the angular contact ball bearing of the present invention has a large load capacity and particularly can bear a large thrust load as described above, the angular contact ball bearing is suitably used to support a ball screw used mainly to apply linear motion force.

In a ball screw device of the present invention, a nut or a screw shaft of a ball screw is supported by the above angular contact ball bearing. The angular contact ball bearing has a large load capacity and particularly can bear a large thrust load. Thus, since the nut or the screw shaft of the ball screw is supported by the angular contact ball bearing, the ball screw device is suitably used mainly to apply linear motion force.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a front view of an angular contact ball bearing according to an embodiment of the present invention;

FIG. 2 is a back view of the angular contact ball bearing;

FIG. 3A is a cutaway front view of the angular contact ball bearing;

FIG. 3B is a IIIB-O-IIIB cross-sectional view of FIG. 3A;

FIG. 4 is a partially enlarged view of FIG. 3B;

FIG. 5A is a cutaway front view of a separator retainer of the angular contact ball bearing;

FIG. 5B is a side view of the separator retainer;

FIG. 6A is a cutaway front view of a different separator retainer;

FIG. 6B is a side view of the separator retainer;

FIG. 7 is a cutaway front view of a part of the angular contact ball bearing, showing a state where the separator retainer becomes locked between adjacent two balls;

FIG. 8 is a longitudinal cross-sectional view of a part of the angular contact ball bearing, showing a state where the separator retainer falls off from bearing rings;

FIG. 9 is a cutaway front view of a part of the angular contact ball bearing, showing the maximum tilt angle of the separator retainer between adjacent two balls;

FIG. 10 is a dimension table showing a preferable range of an outer diameter dimension H and a width dimension W of the separator retainer;

FIG. 11 is a cutaway front view of the angular contact ball bearing, showing a state where all balls and separator retainers of the angular contact ball bearing are gathered in the circumferential direction of the bearing;

FIG. 12 is a cutaway front view of the separator retainer, showing an appropriate dimensional relationship between the ball and the separator retainer;

FIG. 13A is a cutaway front view of a separator retainer that is a modification of FIG. 5A;

FIG. 13B is a side view of a modification of FIG. 5B;

FIG. 14A is a cutaway front view of a separator retainer that is a modification of FIG. 6;

FIG. 14B is a side view of the modification of FIG. 6;

FIG. 15 is a diagram showing the entire configuration of an injection molding machine in which the angular contact ball bearing shown in FIG. 1 to FIG. 4 is used; and

FIG. 16 is a longitudinal cross-sectional view of a general angular contact ball bearing.

### DESCRIPTION OF EMBODIMENTS

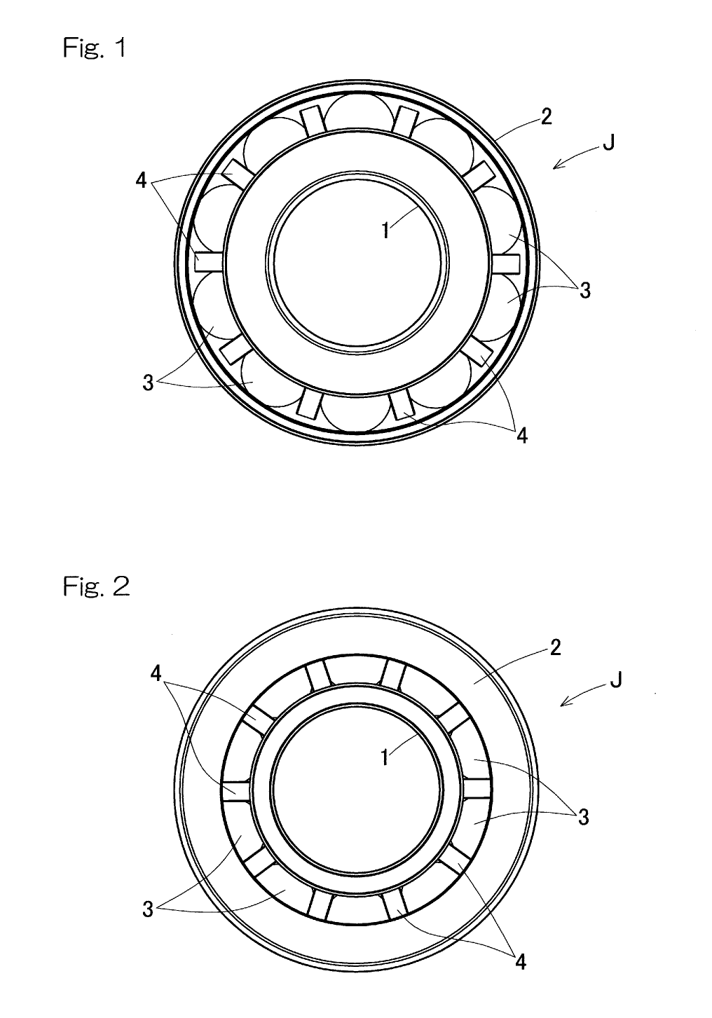

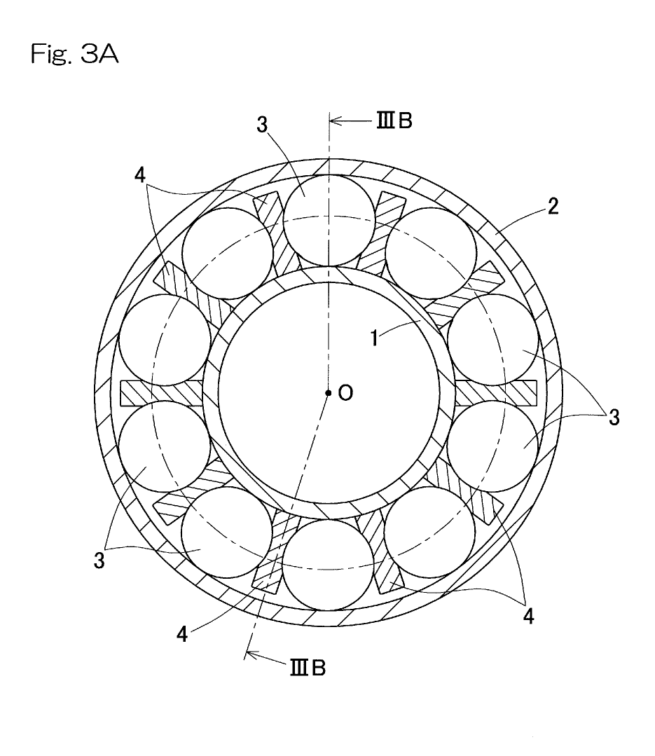

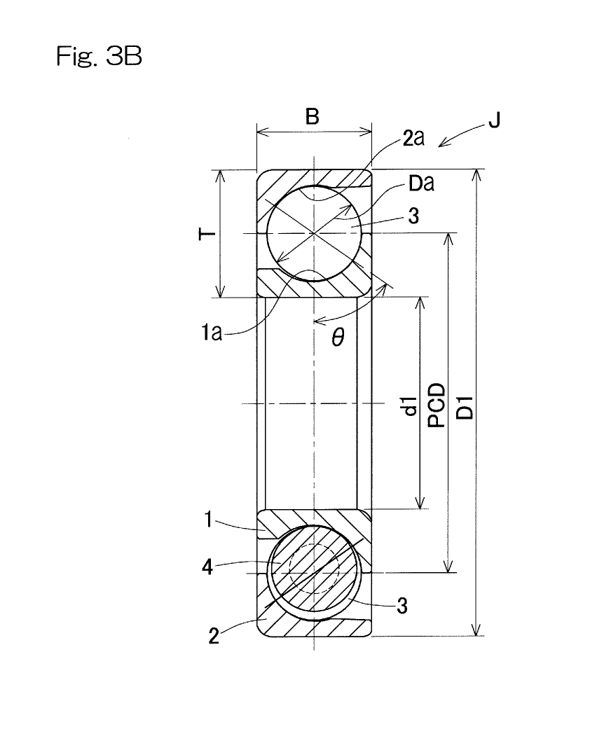

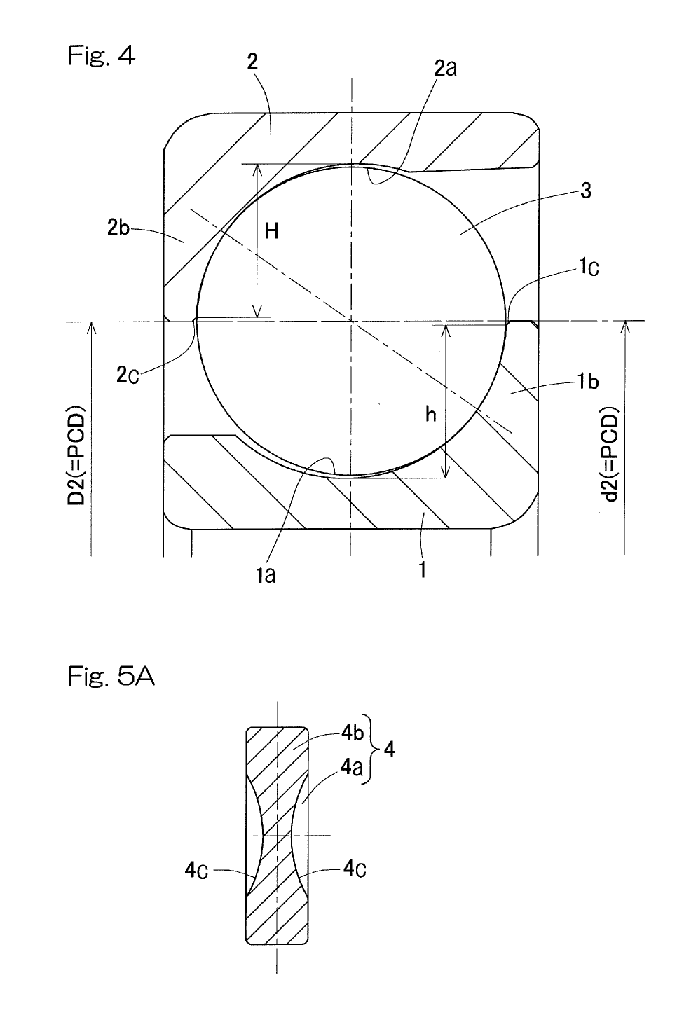

Embodiments of the present invention will be described with reference to the drawings. FIG. 1 is a front view of an angular contact ball bearing according to an embodiment of the present invention; FIG. 2 is a back view of the angular contact ball bearing; FIG. 3A is a cutaway front view of the angular contact ball bearing; FIG. 3B is a IIIB-O-IIIB cross-sectional view of FIG. 3A; and FIG. 4 is a partially enlarged view of FIG. 3B.

As shown in FIG. 1 and FIG. 2, the angular contact ball bearing J includes an inner ring 1 having an outer peripheral surface formed with an inner ring raceway groove 1a (FIG. 3B), an outer ring 2 having an inner peripheral surface formed with an outer ring raceway groove 2a (FIG. 3B), and a plurality of balls rollably interposed between the inner ring raceway groove la and the outer ring raceway groove 2a. The plurality of balls 3 are retained by a plurality of separator retainers 4 that are interposed between the adjacent balls 3 and that are spaced apart from each other. In the following description, the “inner ring raceway groove” and the “outer ring raceway groove” are each sometimes referred to simply as “raceway groove”.

In FIG. 3B, the angular contact ball bearing J has an inner diameter dimension d1, an outer diameter dimension D1, and a width dimension B that conform to the ISO standard. The dimensions other than those dimensions are determined so as to satisfy the following conditions (1) to (4), regardless of the bearing size.

(1) A contact angle θ of each ball 3 is within the range of 45° to 65°. In the case of the shown example, the contact angle θ is 55°. When the contact angle θ is not less than 45°, the load capacity for thrust load is larger than that for radial load. When the contact angle θ of each ball 3 is not greater than 65°, the balls 3 can be prevented from moving onto portions of the inner ring 1 and the outer ring 2 at the back side with respect to the raceway grooves 1a and 2a, that is, shoulder portions 1b and 2b.

(2) The diameter Da of each ball 3 is not less than 68% of a radial cross-section thickness T. The radial cross-section thickness T is ½ of the difference between an outer diameter dimension D1 of the outer ring 2 and an inner diameter dimension d1 of the inner ring 1. In the case of general angular contact ball bearings, the diameter Da of each ball 3 is not greater than 68% of the radial cross-section thickness T. Thus, the angular contact ball bearing J of the present embodiment has a ratio of the diameter Da of each ball 3 relative to the radial cross-section thickness T higher than that of the general angular contact ball bearings. The higher the ratio is, the larger the load capacity of the bearing is.

(3) In FIG. 4, the outer diameter dimension d2 of the shoulder portion 1b of the inner ring 1 and the inner diameter dimension D2 of the shoulder portion 2b of the outer ring 2 are equal to the pitch circle diameter PCD of the balls 3. Thus, the height of the shoulder portion 1b of the inner ring 1 and the height of the shoulder portion 2b of the outer ring 2 are increased as much as possible in view of constraints on processing. When the heights of the shoulder portions 1b and 2b are increased as described above, the load capacity for thrust load is increased. In addition, it is possible to increase the contact angle θ of each ball 3 to be equal to or greater than 45°. When the heights of the shoulder portions 1b and 2b are set so as to exceed the pitch circle diameter PCD of the balls 3, grinding for the raceway grooves 1a and 2a becomes difficult.

(4) The groove depth h of a deepest portion of the inner ring raceway groove 1a with respect to the shoulder portion 1b of the inner ring 1 and the groove depth H of the deepest portion of the outer ring raceway groove 2a with respect to the shoulder portion 2b of the outer ring 2 are not less than 47% of the diameter Da of each ball 3. The groove depth h of the inner ring bearing groove 1a is a depth excluding a chamfer 1c provided at the boundary between the outer peripheral surface of the shoulder portion 1b and the inner ring raceway groove 1a. Similarly, the depth H of the outer ring raceway groove 2a is a depth excluding a chamfer 2c provided at the boundary between the inner peripheral surface of the shoulder portion 2b and the outer ring raceway groove 2a. When the outer diameter dimension d2 of the shoulder portion 1b of the inner ring 1 and the inner diameter dimension D2 of the shoulder portion 2b of the outer ring 2 are equal to the pitch circle diameter PCD of the balls 3 as described in (3), the substantial groove depths h and H excluding the chamfers 1c and 2c satisfy the above ratio to the diameter Da of each ball 3, that is, is not less than 47% of the diameter Da of each ball 3. Thus, the condition (4) is substantially identical with the condition (3).

When the diameter Da of each ball 3 is made larger and the heights of the shoulder portions 1b and 2b of the inner ring 1 and the outer ring 2 are made larger than those in the general angular contact ball bearings as described above, a space formed between the inner ring 1 and the outer ring 2 in which no balls 3 are present becomes narrow, whereby it is difficult to incorporate thereinto a retainer of a ladder type or comb type. Therefore, the balls 3 are retained by the plurality of separator retainers 4.

Not only Resins such as PA (polyamide), PPS (polyphenylene sulfide), and PEEK (polyether ether ketone) but also ceramics, aluminum alloys, copper alloys, stainless steel, and the like may be used for the separator retainers 4. When the separator retainers 4 are formed from a resin, grease holding ability is enhanced, resulting in further improved lubrication.

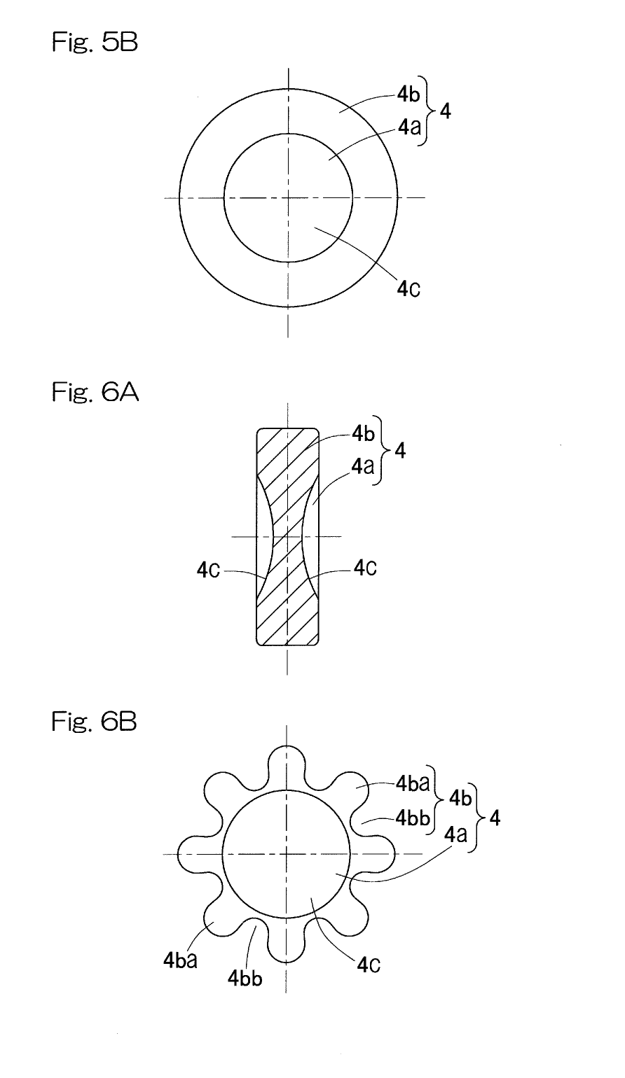

As shown in FIG. 5A and FIG. 5B, each separator retainer 4 includes: a contact portion 4a that contacts the balls 3 at both sides; and a displacement prevention portion 4b that spreads from the contact portion 4a along a plane perpendicular to the pitch circle of arrangement of the respective balls 3 (a plane parallel to the drawing sheet of FIG. 5B). Both side surfaces of the contact portion 4a are spherically recessed toward the center side, and these recessed portions form pockets 4c into which the balls 3 at both sides are partially fitted. Each pocket 4c has, for example, a concave spherical shape having a curvature slightly larger than those of the balls 3. However, each pocket 4c may have a circular conical shape or a shape having a Gothic arch cross-section. Alternatively, each pocket 4c may have a ring shape opened on both surfaces at the center thereof.

In the example in FIG. 5A and FIG. 5B, the displacement prevention portion 4b has a shape uniformly spreading in all directions along the plane perpendicular to the pitch circle of arrangement of the respective balls 3. However, as shown in FIG. 6A and FIG. 6B, the displacement prevention portion 4b may have a shape in which projection portions 4ba greatly extending to a large extent from the contact portion 4a and recess portions 4bb extending to a small extent from the contact portion 4a are alternately arranged. With the petal shape as shown in FIG. 6A and FIG. 6B, a lubricant such as grease can be held in the recess portions 4bb.

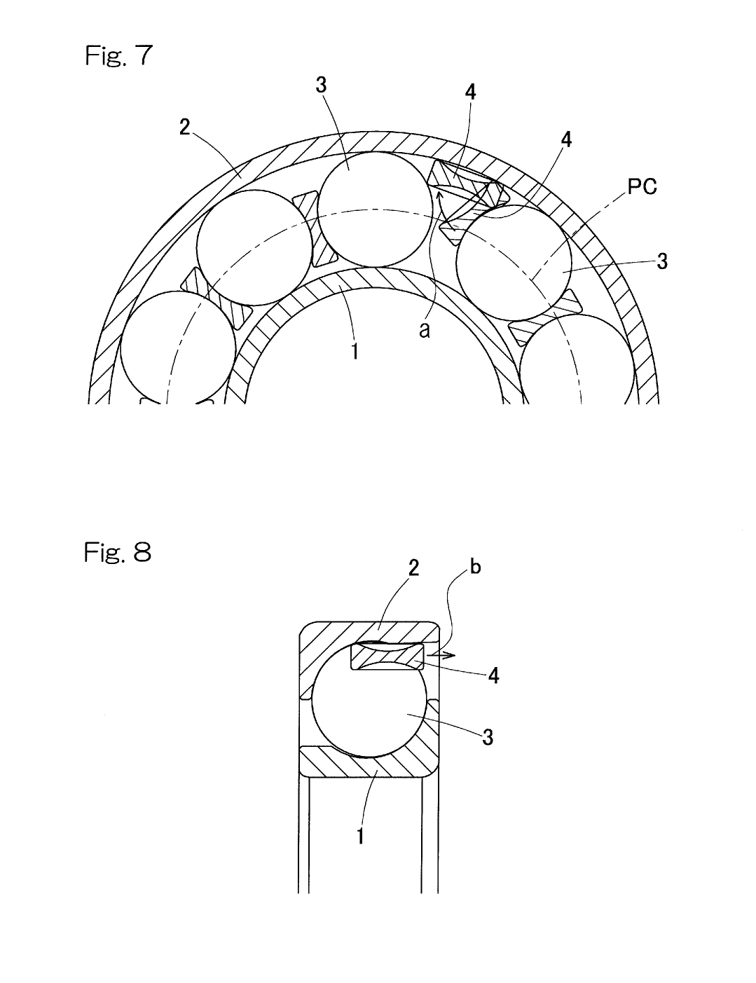

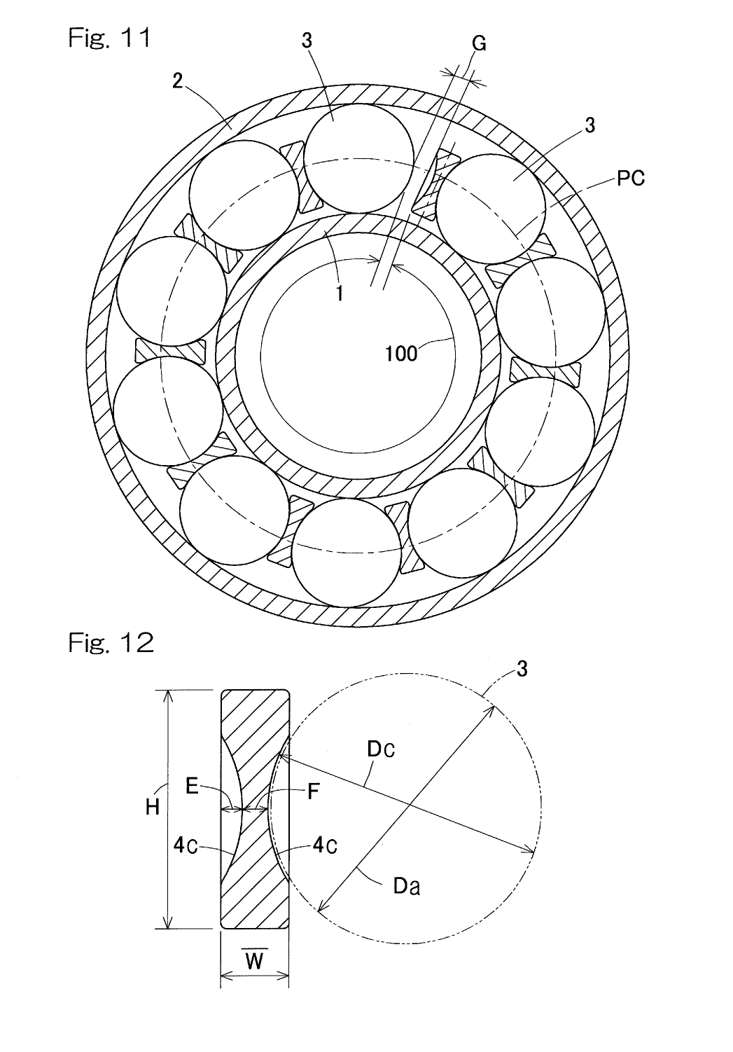

Meanwhile, during rotation of the angular contact ball bearing J, each separator retainer 4 revolves while being brought into contact with and guided by the balls 3 and the bearing grooves 1a and 2a. In this condition, as shown in FIG. 7, if the dimension of each separator retainer 4 is inappropriate, the posture of the separator retainer 4 becomes unstable, and the separator retainer 4 comes into contact with the inner surface of the outer ring 2 due to centrifugal force, and tilts in the circumferential direction from a radial position as indicated by an arrow a. If an extent of the tilt is large, the separator retainer 4 becomes positioned sideways relative to the circumferential direction, and is brought into a state of being stuck between the adjacent balls 3, that is, a locked state. When the separator retainer 4 is brought into a locked state as described above, the balls 3 are braked, so that revolution of the balls 3 is inhibited. In addition, if the outer diameter dimension H and the width dimension W of each separator retainer 4 shown in FIG. 12 are small, the separator retainer 4 may fall off through a gap between the bearing rings in the direction indicated by an arrow b as shown in FIG. 8.

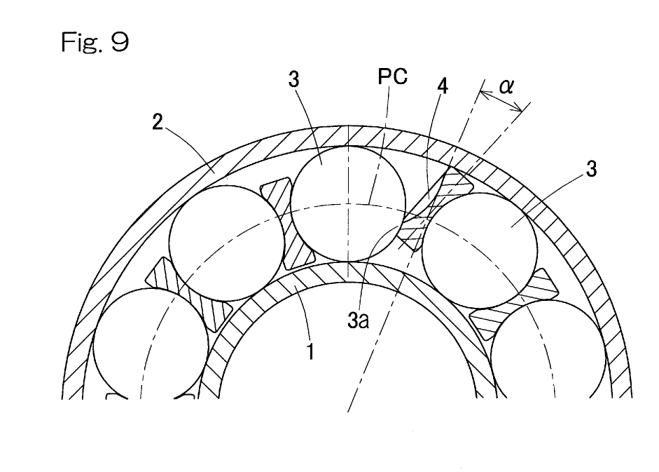

Therefore, the size of each separator retainer 4 is set such that, as shown in FIG. 9, when the separator retainer 4 is tilted between the adjacent balls 3 at a maximum angle α in the circumferential direction of the bearing from the radial direction of the bearing, an outer end portion, in the radial direction, of the separator retainer 4 comes into contact with one of the balls 3 (the right side in

FIG. 9) and the inner surface of the outer ring 2 of the bearing and an inner end portion, in the radial direction, of the separator retainer 4 comes into contact with a portion 3a of the other ball 3 (the left side in FIG. 9) at the inner diameter side with respect to the pitch circle PC. When the ratios of the outer diameter dimension H and the width dimension W of the separator retainer 4 to the diameter Da (hereinafter, sometimes referred to as “ball diameter”) of each ball 3 are set high as described above, tilt of the separator retainer 4 during revolution can be inhibited, the separator retainer 4 can be prevented from being brought into a locked state where the separator retainer 4 becomes stuck between the adjacent balls 3 to inhibit rotation of the bearing, and at the same time, a situation in which the separator retainer 4 falls off through the gap between the bearing rings can be avoided. Accordingly, the angular contact ball bearing J that can smoothly rotate and that includes the separator retainers 4 is obtained.

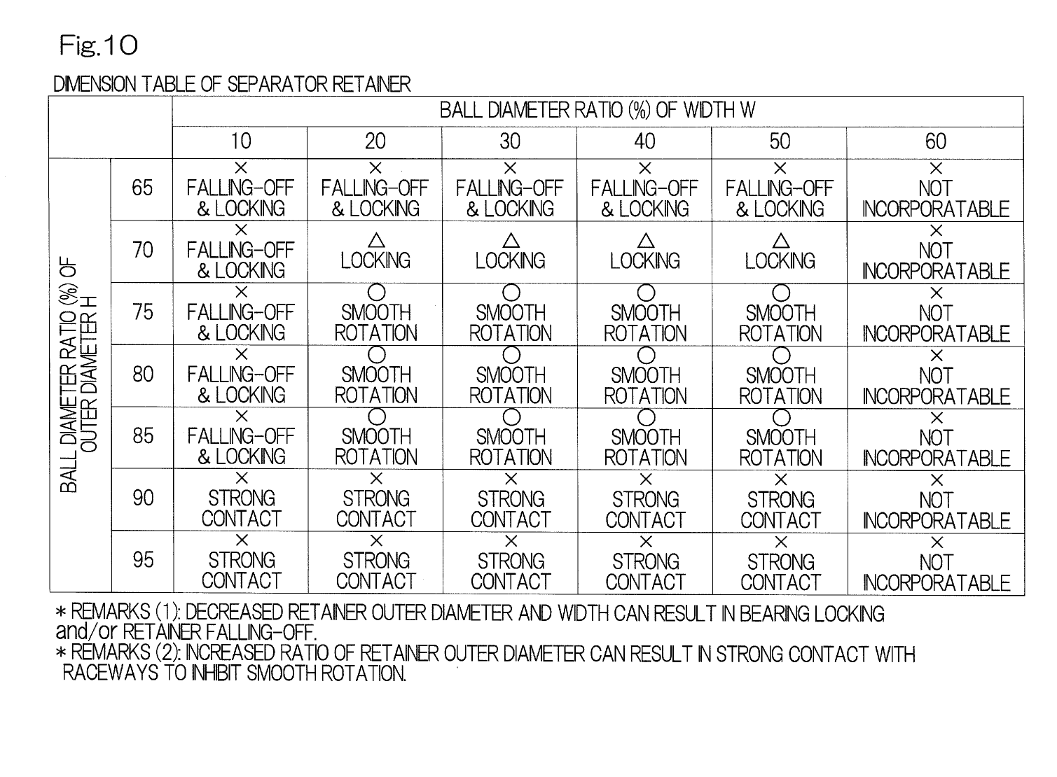

A preferable range of the outer diameter dimension H and the width dimension W of each separator retainer 4 is as shown in FIG. 10. In the range marked with ∘ where smooth rotation of the bearing is achieved, the outer diameter dimension H of the separator retainer 4 is 75 to 85% of the diameter Da of each ball, and the width dimension W of the separator retainer 4 is 20 to 50% of the diameter Da of the balls. When the outer diameter dimension H and the width dimension W of the separator retainer 4 fall outside this range, a problem of falling-off of the retainer and locking of the bearing, or excessively strong contact with raceway surfaces, arises. When the width dimension W exceeds 50% of the diameter Da of each ball, it is impossible to fit the separator retainer 4 into a bearing having an ordinary number of balls.

During rotation of the bearing, each separator retainer 4 revolves while being brought into contact with and guided by the balls 3 and raceway surfaces 1a and 2a. The gaps between the separator retainers 4 and the balls 3 are important for inhibiting sound of collision between the separator retainers 4 and the balls 3 for smooth rotation. When the gaps between the separator retainers 4 and the balls 3 are large, the separator retainers 4 come into contact with the raceway groove 1a or 2a. Accordingly, rotational torque increases, and problems such as heat generation arise. In addition, sound of collision between the separator retainers 4 and the balls 3 becomes loud, which causes noise. Furthermore, when the gaps between the separator retainers 4 and the balls 3 are small, the separator retainer 4 and the balls 3 thermally expand due to a temperature rise associated with rotation of the bearing, and the gaps between the separator retainers 4 and the balls 3 are reduced or eliminated. Thus, friction and heat are generated between the separator retainers 4 and the balls 3, so that the life of the bearing is shortened.

Therefore, the separator retainers 4 for an angular contact ball bearing are set such that, as shown in FIG. 11, when all the balls 3 and the separator retainers 4 are gathered in the circumferential direction of the bearing to form an assembly 100, the gap (final gap) G between both ends of the assembly 100 is 15 to 25% of the diameter Da of each ball 3. Accordingly, an appropriate gap G is maintained between the separator retainer 4 and the ball 3 during rotation of the bearing even in consideration of thermal expansion of the balls 3 and the separator retainers 4, whereby the bearing can be smoothly rotated. Specifically, an increase in rotational torque and heat generation that occur due to the separator retainer 4 being moved outward in the radial direction due to centrifugal force to come into contact with the raceway groove 2a of the outer ring 2, and noise that occurs due to sound of collision between the ball 3 and the separator retainer 4 becoming loud, when the gap G between the separator retainer 4 and the ball 3 is large, can be avoided. In addition, friction and heat generation that occur due to the gap G between the separator retainer 4 and the ball 3 being eliminated due to thermal expansion of the balls 3 and the separator retainers 4 by a temperature rise during rotation of the bearing, when the gap G between the separator retainer 4 and the ball 3 is small, can be avoided.

FIG. 12 shows an appropriate dimensional relationship between the ball and the separator retainer in the angular contact ball bearing. As shown in FIG. 12, in the dimensional relationship between the ball 3 and the separator retainer 4, when: the spherical diameter Dc of each pocket 4c of the separator retainer 4 is 105 to 125% of the ball diameter Da; the groove depth E of the separator retainer 4 is 10 to 30% of the ball diameter Da; and the bottom thickness F of the pockets 4c of the separator retainer 4 is 5 to 20% of the ball diameter Da, rotation of the bearing becomes more smooth.

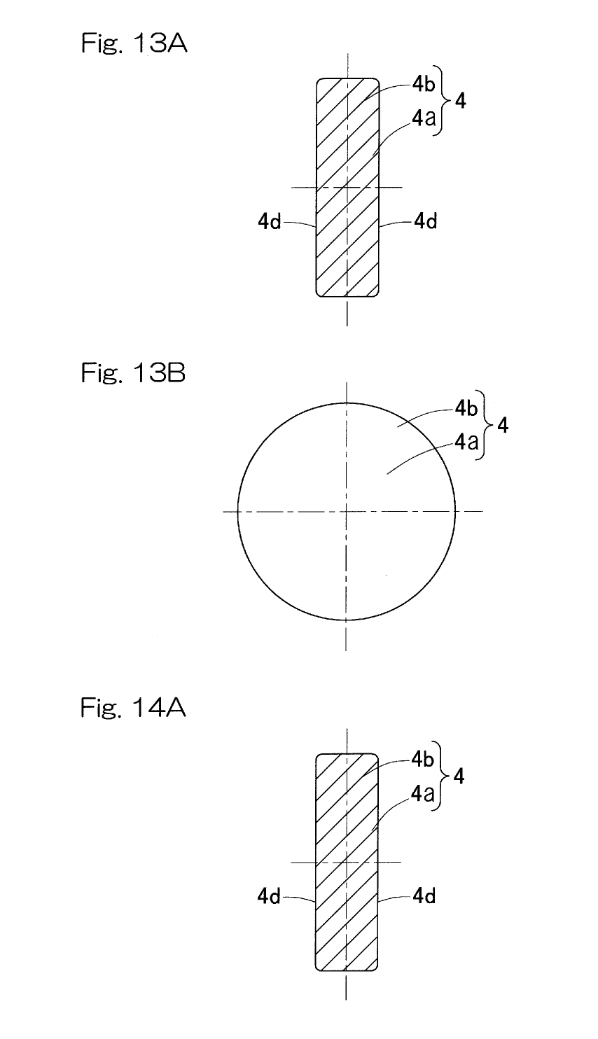

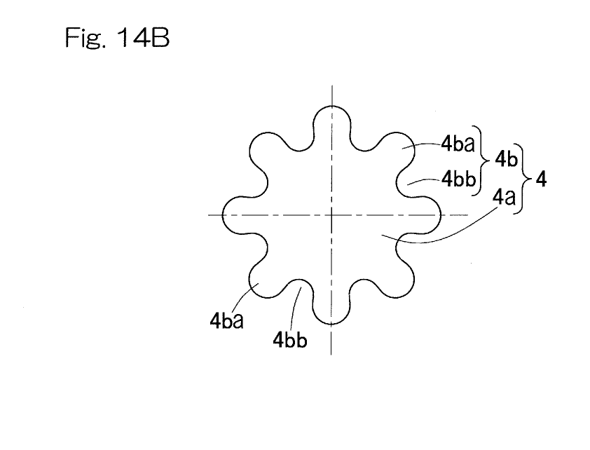

In each of the aforementioned separator retainers 4 in FIG. 5A and FIG. 5B and in FIG. 6A and FIG. 6B, both side surfaces of the contact portion 4a have a recess shape, but, as shown in FIG. 13A and FIG. 13B and in FIG. 14A and FIG. 14B showing modifications of these separator retainers 4, both side surfaces of the contact portion 4a may be flat surfaces 4d. In the case where both side surfaces of the contact portion 4a are spherically recessed toward the center side, the balls 3 and the contact portion 4a are brought into surface contact with each other, and the contact portion 4a is less likely to be worn off, but frictional torque becomes large. In addition, in the case where both side surfaces of the contact portion 4a are flat, the balls 3 and the contact portion 4a are brought into point or line contact with each other, and the frictional torque is small, but wear of the contact portion 4a becomes great. The separator retainers 4 may be selectively used according to a required use.

In the angular contact ball bearing J configured as described above, the respective balls 3 are retained by the plurality of separator retainers 4 spaced apart from each other, and not by a retainer of a ladder type, a comb type, or the like having pillar portions. Thus, damage of pillar portions due to delay or advance of the balls 3 during rapid acceleration/deceleration rotation does not occur. In addition, since no pillar portions are included, the space between the inner ring 1 and the outer ring 2 is widened accordingly, and thus much grease can be put into the bearing, resulting in improved lubrication. Since the separator retainers 4 are formed from a resin, the grease holding ability is enhanced, resulting in further improved lubrication.

In the angular contact ball bearing J, the load capacity of the entire angular contact ball bearing J is large since the diameter Da of each ball 3 is large, and the load capacity for thrust load is large since the heights of the shoulder portions 1b and 2b are large. Thus, the angular contact ball bearing J is suitable for supporting a ball screw used mainly to apply linear motion force. For example, the angular contact ball bearing J is suitable for supporting a ball screw used in a mechanism for causing a resin material extrusion screw to advance/retract or a mechanism for clamping a mold in an injection molding machine.

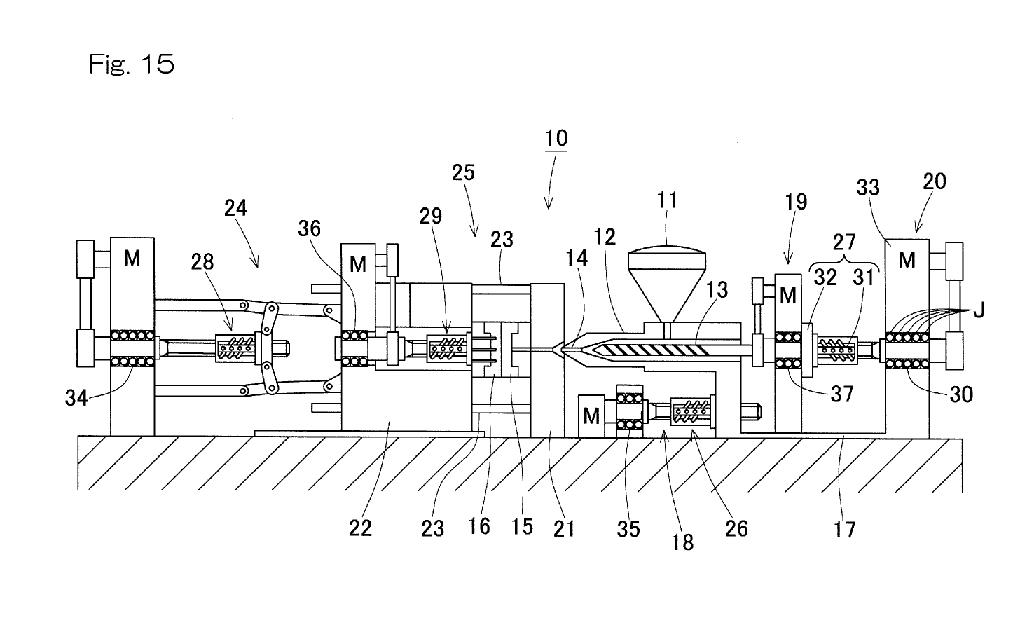

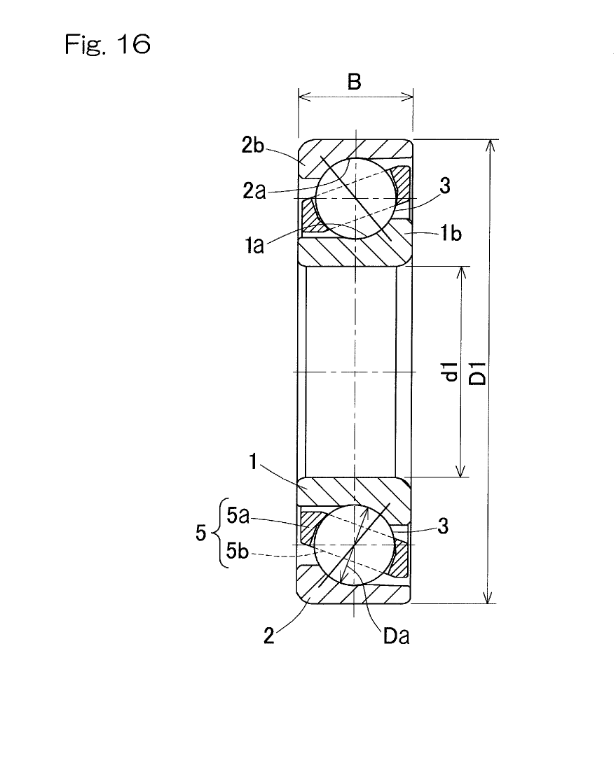

FIG. 15 is a diagram showing the entire configuration of an injection molding machine in which the angular contact ball bearing J shown in FIG. 1 to FIG. 4 is used. The injection molding machine 10 is of an in-line screw type in which a resin supplied from a hopper 11 into a heating cylinder 12 is heated and melted by a heater, which is not shown, while being kneaded by an extrusion screw 13, and the heated and melted resin is extruded from a nozzle 14 by the extrusion screw 13 and injected between a pair of molds 15 and 16.

The heating cylinder 12 is mounted on a movable stand 17 that is movable in the right-left direction in FIG. 15 which is the direction of the central axis of the extrusion screw 13. The movable stand 17 is caused to advance/retract by an injection stand moving unit 18. The extrusion screw 13 is rotated by a screw unit 19 in order to knead the resin. In addition, the extrusion screw 13 can be caused to advance/retract in the right-left direction in FIG. 15 by an injection unit 20, and is caused to advance leftward when the melted resin is injected into the molds 15 and 16.

The molds 15 and 16 are mounted on a fixed platen 21 and a movable platen 22, respectively. The movable platen 22 can be caused to advance/retract in the right-left direction in FIG. 15 along a guide bar 23 provided to the fixed platen 21, and is configured to move close to or away from the fixed platen 21. The movable platen 22 is caused to advance/retract by a mold clamping unit 24 composed of a toggle mechanism. In addition, the movable platen 22 is provided with an eject unit 25 that detaches the mold 16 from the mold 15 and takes out a molded article.

Ball screw devices 26, 27, 28, and 29 are used as feed mechanisms of the injection stand moving unit 18, the injection unit 20, the mold clamping unit 24, and the eject unit 25, respectively. The screw unit 19 is a mechanism to merely rotate the extrusion screw 13, and thus is not provided with a ball screw device. The structures of the ball screw devices 26, 27, 28, and 29 are basically the same. Thus, a description will be given with the ball screw device 27 of the injection unit 20 as an example.

The ball screw device 27 includes: a screw shaft 31 that is rotatably supported by a bearing device 30 and that extends in the right-left direction; and a nut 32 that is screwed to the screw shaft 31. The ball screw device 27 is configured such that the nut 32 advances/retracts in the right-left direction by rotating the screw shaft 31 by a motor 33. In the case of the ball screw device 27 of the injection unit 20, a proximal end of the extrusion screw 13 is coupled to the nut 32. The bearing device 30 includes a plurality of (for example, five) aligned angular contact ball bearings J shown in FIG. 1 to FIG. 4.

The ball screw device 27 of the injection unit 20 generates large linear motion force for injecting the melted resin and keeping the pressure of the melted resin. In addition, the ball screw device 28 of the mold clamping unit 24 also generates large linear motion force for receiving an internal pressure generated within the molds 15 and 16 when the melted resin is injected. In the bearing device 30 of the injection unit 20 and a bearing device 34 of the mold clamping unit 24 which receive such large thrust loads, more angular contact ball bearings J are aligned than in a bearing device 35 of the injection stand moving unit 18 and a bearing device 36 of the eject unit 25. Also in a bearing device 37 of the screw unit 19 which supports the extrusion screw 13, angular contact ball bearings J shown in FIG. 1 to FIG. 4 are used.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . Inner ring

1a . . . Inner ring raceway groove

1b . . . Shoulder portion (portion at back side with respect to inner ring raceway groove)

2 . . . Outer ring

2a . . . Outer ring raceway groove

2b . . . Shoulder portion (portion at back side with respect to outer ring raceway groove)

3 . . . Ball

4 . . . Separator retainer

26, 27, 28, 29 . . . Ball screw device

31 . . . Screw shaft

2 . . . Nut

D1 . . . Outer diameter dimension of outer ring

D2 . . . Inner diameter dimension of portion of outer ring at back side with respect to outer ring raceway groove

Da . . . Diameter of ball

H . . . Groove depth of deepest portion of outer ring raceway groove

J . . . Angular contact ball bearing

d1 . . . Inner diameter dimension of inner ring

d2 . . . Outer diameter dimension of portion of inner ring at back side with respect to inner ring raceway groove

h . . . Groove depth of deepest portion of inner ring raceway groove

G . . . Final gap

PC . . . Pitch circle of balls

PCD . . . Pitch circle diameter of balls

α . . . Maximum tilt angle

θ . . . Contact angle

What is claimed is:

1. An angular contact ball bearing comprising:
an inner ring having an outer peripheral surface formed with an inner ring raceway groove;
an outer ring having an inner peripheral surface formed with an outer ring raceway groove;
a plurality of balls rollably interposed between the inner ring raceway groove and the outer ring raceway groove; and
a plurality of separator retainers configured to retain the plurality of balls, the separator retainers being interposed between the adjacent balls and that are spaced apart from each other,
wherein a contact angle of each ball is within a range of 45° to 65°.

2. The angular contact ball bearing as claimed in claim 1, wherein the balls each has a diameter that is not less than 68% of ½ of a difference between an outer diameter dimension of the outer ring and an inner diameter dimension of the inner ring.

3. The angular contact ball bearing as claimed in claim 1, wherein a groove depth of a deepest portion of the inner ring raceway groove with respect to a portion of the inner ring at a back side with respect to the inner ring raceway groove and a groove depth of a deepest portion of the outer ring raceway groove with respect to a portion of the outer ring at the back side with respect to the outer ring raceway groove are not less than 47% of the diameter of each ball.

4. The angular contact ball bearing as claimed in claim 1, wherein an outer diameter dimension of the portion of the inner ring at the back side with respect to the inner ring raceway groove and an inner diameter dimension of the portion of the outer ring at the back side with respect to the outer ring raceway groove are equal to a pitch circle diameter of the balls.

5. The angular contact ball bearing as claimed in claim 2, wherein the separator retainers each has an outer diameter and a width that are set to magnitudes such that, when the separator retainer is tilted between the adjacent two balls at a maximum angle in a circumferential direction of the bearing from a radial direction of the bearing, an radially outer end portion of the separator retainer comes into contact with one of the balls and an inner surface of the outer ring and an radially inner end portion of the separator retainer comes into contact with a portion of the other ball at an inner diameter side with respect to a pitch circle.

6. The angular contact ball bearing as claimed in claim 5, wherein the separator retainers each has an outer diameter dimension that is 75 to 85% of the diameter of each ball, and each has a width dimension that is 20 to 50% of the diameter of each ball.

7. The angular contact ball bearing as claimed in claim 1, wherein, when all the balls and the separator retainers are gathered in a circumferential direction of the bearing to form an assembly, a gap between opposite ends of the assembly is 15 to 25% of the diameter of each ball.

8. The angular contact ball bearing as claimed in claim 1, wherein the angular contact ball bearing is used to support a ball screw.

9. A ball screw device in which a nut or a screw shaft of a ball screw is supported by the angular contact ball bearing as claimed in claim 1.
